(19) United States
(12) Patent Application Publication
(10) Pub. No.: US 2024/0270242 A1
(43) Pub. Date: Aug. 15, 2024

(54) APPARATUS FOR DRIVING ASSISTANCE AND METHOD FOR DRIVING ASSISTANCE

(71) Applicant: HL Klemove Corp., Incheon (KR)

(72) Inventor: Seokwon KIM, Seoul (KR)

(73) Assignee: HL Klemove Corp., Incheon (KR)

(21) Appl. No.: 18/368,157

(22) Filed: Sep. 14, 2023

(30) Foreign Application Priority Data
Feb. 14, 2023 (KR) 10-2023-0019484

(51) Int. Cl. B60W 30/095; B60W 40/04; G06V 20/58

(52) U.S. Cl. CPC B60W 30/0956; B60W 40/04; G06V 20/58; B60W 2420/403; B60W 2420/408

(57) ABSTRACT

Disclosed herein is a driving assistance system according to one embodiment including at least one memory in which a program for determining a cut-in vehicle is stored, and at least one processor configured to execute the stored program, The at least one processor acquires image data from a camera, identifies a first nearby vehicle traveling in a lane near a vehicle from the image data, identifies a front wheel of the first nearby vehicle from the image data, and determines whether the first nearby vehicle attempts to cut into a travel lane in which the vehicle is traveling based on information on the front wheel of the first nearby vehicle.

### CROSS-REFERENCE TO RELATED APPLICATION

This application claims the benefit of Korean Patent Application No. 10-2023-0019484, filed on Feb. 14, 2023 in the Korean Intellectual Property Office, the disclosure of which is incorporated herein by reference.

### BACKGROUND

### 1. Field

Embodiments of the present disclosure relate to an apparatus for driving assistance and a method for driving assistance, which may recognize a nearby vehicle cutting into a lane in which a vehicle is traveling.

### 2. Description of the Related Art

Recently, research on vehicles equipped with an advanced driver assistance system (ADAS) for actively providing information on a vehicle state, a driver state, or a surrounding environment in order to reduce a driver's burden and enhance convenience has been actively progressed.

For example, an ADAS mounted on vehicles may perform functions of lane departure warning (LDW), lane keeping assist (LKA), high beam assist (HBA), autonomous emergency braking (AEB), traffic sign recognition (TSR), adaptive cruise control (ACC), blind spot detection (BSD), etc.

### SUMMARY

Therefore, it is an aspect of the present disclosure to provide an apparatus for driving assistance and a method for driving assistance, which can improve the reliability of determination by determining whether a nearby vehicle cuts into a lane based on an image captured through a camera.

Additional aspects of the disclosure will be set forth in part in the description which follows and, in part, will be obvious from the description, or may be learned by practice of the disclosure.

In accordance with one aspect of the present disclosure, an apparatus for driving assistance includes at least one memory in which a program for determining a cut-in vehicle is stored, and at least one processor configured to execute the stored program. The at least one processor acquires image data from a camera, identifies a first nearby vehicle traveling in a lane near a vehicle from the image data, identifies a front wheel of the first nearby vehicle from the image data, and determines whether the first nearby vehicle attempts to cut into a travel lane in which the vehicle is traveling based on information on the front wheel of the first nearby vehicle.

The at least one processor may acquire a steering angle of the front wheel of the first nearby vehicle based on the image data.

The at least one processor may determine that the first nearby vehicle is the cut-in vehicle based on the steering angle of the front wheel of the first nearby vehicle exceeding a reference angle.

The at least one processor may determine a predicted travel route of the first nearby vehicle based on the information on the front wheel of the first nearby vehicle.

The at least one processor may determine that the first nearby vehicle is the cut-in vehicle based on the predicted travel route of the first nearby vehicle that is directed to the travel lane.

The at least one processor may determine that the predicted travel route of the first nearby vehicle is directed to the travel lane based on a steering angle of the front wheel of the first nearby vehicle exceeding a reference angle.

The at least one processor may determine the cut-in vehicle based on the image data acquired from the camera when a speed of the vehicle is smaller than or equal to a predetermined reference value, and determine the cut-in vehicle based on at least one of radar data acquired from a radar provided in the vehicle or light detection and ranging (LiDAR) data acquired from a LiDAR provided in the vehicle when the speed of the vehicle exceeds the predetermined reference value.

In accordance with another aspect of the present disclosure, an apparatus for driving assistance includes a camera provided on a vehicle, and at least one processor configured to execute a program stored in a memory. The at least one processor acquires image data from the camera, identifies a first nearby vehicle that is traveling in a lane near the vehicle from the image data, identifies a front wheel of the first nearby vehicle from the image data, and determines whether the first nearby vehicle is a vehicle that attempts to cut into a travel lane in which the vehicle is traveling based on information on the front wheel of the first nearby vehicle.

In accordance with still another aspect of the present disclosure, a driving assistance method includes acquiring image data from a camera provided on a side surface of a vehicle, recognizing a first nearby vehicle that is traveling in a lane near the vehicle from the image data, recognizing a front wheel of the first nearby vehicle from the image data, and determining whether the first nearby vehicle is a vehicle that attempts to cut into a travel lane in which the vehicle is traveling based on information on the front wheel of the first nearby vehicle.

The recognizing of the first nearby vehicle may include acquiring a steering angle of the front wheel of the first nearby vehicle based on the image data.

The determining of whether the first nearby vehicle is the cut-in vehicle may include determining that the first nearby vehicle is the cut-in vehicle, based on the steering angle of the front wheel of the first nearby vehicle exceeding a reference angle.

The determining of whether the first nearby vehicle is the cut-in vehicle may include determining a predicted travel route of the first nearby vehicle based on the information on the front wheel of the first nearby vehicle.

The determining of whether the first nearby vehicle is the cut-in vehicle may include determining that the first nearby vehicle is the cut-in vehicle based on the predicted travel route of the first nearby vehicle that is directed to the travel lane.

The determining of whether the first nearby vehicle is the cut-in vehicle may include determining that the predicted travel route of the first nearby vehicle is directed to the travel lane based on a steering angle of the front wheel of the first nearby vehicle exceeding a reference angle.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a block diagram illustrating operations of a vehicle and a driving assistance system included therein according to one embodiment;

FIG. 2 is a view illustrating fields of view of a camera, a radar, and a light detection and ranging (LiDAR) included in the vehicle according to one embodiment;

FIG. 3 is a block diagram illustrating operations performed by a controller of the driving assistance system according to one embodiment;

FIG. 4 is a view illustrating a cut-in situation of a nearby vehicle, which is one situation to which the driving assistance system needs to respond according to one embodiment;

FIG. 5 is a flowchart illustrating a driving assistance method according to one embodiment;

FIG. 6 is a view illustrating a situation in which a cut-in vehicle is recognized by the driving assistance method according to one embodiment;

FIG. 7 is a flowchart specifically illustrating the driving assistance method according to one embodiment;

FIG. 8 is a view illustrating data used in the driving assistance method according to one embodiment;

FIG. 9 is a view illustrating an operation in response to a cut-in vehicle in the driving assistance method according to one embodiment;

FIG. 10 is another flowchart illustrating the driving assistance method according to one embodiment;

FIG. 11 is still another flowchart of the driving assistance method according to one embodiment; and

FIG. 12 is a view illustrating data used in the driving assistance method according to one embodiment.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing operations described is an example; however, the sequence of and/or operations is not limited to that set forth herein and may be changed as is known in the art, with the exception of operations necessarily occurring in a particular order. In addition, respective descriptions of well-known functions and constructions may be omitted for increased clarity and conciseness.

Additionally, exemplary embodiments will now be described more fully hereinafter with reference to the accompanying drawings. The exemplary embodiments may, however, be embodied in many different forms and should not be construed as being limited to the embodiments set forth herein. These embodiments are provided so that this disclosure will be thorough and complete and will fully convey the exemplary embodiments to those of ordinary skill in the art. Like numerals denote like elements throughout.

It will be understood that, although the terms first, second, etc. may be used herein to describe various elements, these elements should not be limited by these terms. These terms are only used to distinguish one element from another. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present.

The terminology used herein is for the purpose of describing particular embodiments only and is not intended to be limiting. As used herein, the singular forms “a,” “an,” and “the,” are intended to include the plural forms as well, unless the context clearly indicates otherwise.

The expression, “at least one of a, b, and c,” should be understood as including only a, only b, only c, both a and b, both a and c, both b and c, or all of a, b, and c.

Reference will now be made in detail to the exemplary embodiments of the present disclosure, examples of which are illustrated in the accompanying drawings, wherein like reference numerals refer to like elements throughout.

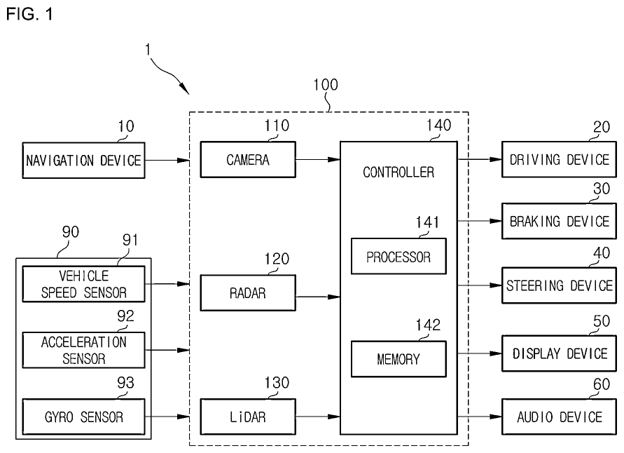

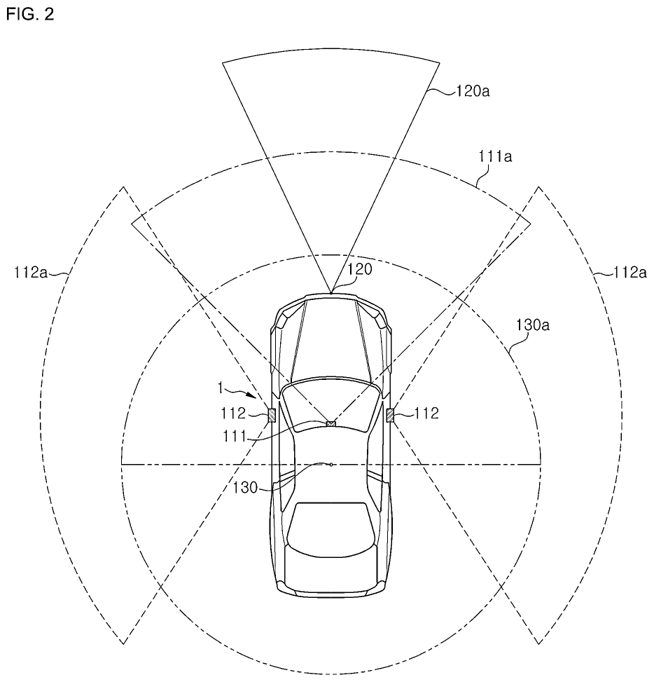

FIG. 1 is a block diagram illustrating operations of a vehicle and a driving assistance system included therein according to one embodiment, and FIG. 2 is a view illustrating fields of view of a camera, a radar, and a light detection and ranging (LiDAR) included in the vehicle according to one embodiment.

As illustrated in FIG. 1, a vehicle 1 may include a navigation device 10, a driving device 20, a braking device 30, a steering device 40, a display device 50, an audio device 60, a behavior sensor 90, and a driving assistance system 100.

The navigation device 10 may generate a route to a destination input by a driver and provide the generated route to the driver. The navigation device 10 may receive Global Navigation Satellite System (GNSS) signals from a GNSS and identify an absolute position (coordinates) of the vehicle 1 based on the GNSS signals. The navigation device 10 may generate the route to the destination based on the position (coordinates) of the destination input by the driver and a current position (coordinates) of the vehicle 1.

The driving device 20 generates power required for moving the vehicle 1. The driving device 20 may include, for example, an engine, an engine management system (EMS), a transmission, and a transmission control unit (TCU).

The engine may generate power for the vehicle 1 to travel, and the EMS may control the engine in response to a driver's acceleration intention transmitted through an accelerator pedal or a request of the driving assistance system 100. The transmission may transmit the power generated by the engine to wheels for deceleration, and the TCU may control the transmission in response to a driver's transmission instruction transmitted through a transmission lever and/or a request of the driving assistance system 100.

Alternatively, the driving device 20 may include a driving motor, a reducer, a battery, a power control device, etc. In this case, the vehicle 1 may be implemented as an electric vehicle.

Alternatively, the driving device 20 may include both engine-related devices and driving motor-related devices. In this case, the vehicle 1 may be implemented as a hybrid electric vehicle.

The braking device 30 may decelerate the vehicle 1. For example, the braking device 30 may include a brake caliper and an electronic brake control module (EBCM). The brake caliper may decelerate the vehicle 1 or stop the vehicle 1 using friction with a brake disk.

The EBCM may control the brake caliper in response to a driver's braking intention transmitted through a brake pedal or a request of the driving assistance system 100. For example, the EBCM may receive a deceleration request including a deceleration from the driving assistance system 100 and electrically or hydraulically control the brake caliper so that the vehicle 1 decelerates based on the requested deceleration.

The steering device 40 may include an electronic power steering control module (EPS). The steering device 40 may change a traveling direction of the vehicle 1, and the EPS may assist with an operation of the steering device 40 so that the driver may easily manipulate a steering wheel in response to a driver's steering intention transmitted through the steering wheel.

In addition, the EPS may control the steering device 40 in response to a request of the driving assistance system 100. For example, the EPS may receive a steering request including a steering torque from the driving assistance system 100 and control the steering device 40 to steer the vehicle 1 based on the requested steering torque.

The display device 50 may include a cluster, a head-up display, a center fascia monitor, etc., and provide various pieces of information and entertainments to the driver through images. For example, the display device 50 may provide traveling information of the vehicle 1, a warning message, etc., to the driver.

The audio device 60 may include a plurality of speakers and provide various pieces of information and entertainments to the driver through sounds. For example, the audio device 60 may provide traveling information of the vehicle 1, a warning message, etc., to the driver.

For example, the behavior sensor 90 may further include at least one of a vehicle speed sensor 91 for detecting a longitudinal speed of the vehicle 1, an acceleration sensor 92 for detecting a longitudinal acceleration and a transverse acceleration of the vehicle 1, or a gyro sensor 93 for detecting a yaw rate, a roll rate, and a pitch rate of the vehicle 1.

The above-described components may transmit or receive data via a vehicle communication network. For example, the above-described components included in the vehicle 1 may transmit or receive data via the vehicle communication network such as Ethernet, media oriented systems transport (MOST), Flexray, a controller area network (CAN), or a local interconnect network (LIN).

The driving assistance system 100 according to one embodiment may communicate with the navigation device 10, the driving device 20, the braking device 30, the steering device 40, the display device 50, and the audio device 60 via the vehicle communication network.

The driving assistance system 100 may use data received from other components of the vehicle 1 as a basis for recognition and determination and transmit control signals for controlling the vehicle 1 to the other components of the vehicle 1 based on the recognition and determination results.

The driving assistance system 100 may provide various functions for safety to the driver and furthermore, may also be used for autonomous driving of the vehicle 1. For example, the driving assistance system may provide functions of lane departure warning (LDW), lane keeping assist (LKA), high beam assist (HBA), autonomous emergency braking (AEB), traffic sign recognition (TSR), adaptive cruise control (ACC), blind spot detection (BSD), etc.

The driving assistance system 100 may include a controller 140, a camera 110, a radar 120, and a LIDAR 130 in order to perform the above-described functions.

The controller 140, the camera 110, the radar 120, and the LiDAR 130 may be provided to be physically separated from one another. For example, the controller 140 may be installed in a housing separated from a housing of the camera 110, a housing of the radar 120, and a housing of the LiDAR 130. The controller 140 may transmit or receive data with the camera 110, the radar 120, or the LiDAR 130 through a wide-bandwidth network.

Alternatively, at least some of the camera 110, the radar 120, the LiDAR 130, or the controller 140 may be integrally provided. For example, the camera 110 and the controller 140 may be provided in the same housing, the radar 120 and the controller 140 may be provided in the same housing, or the LiDAR 130 and the controller 140 may be provided in the same housing.

The camera 110 may capture surroundings of the vehicle 1 and acquire image data of the surroundings of the vehicle 1. For example, as illustrated in FIG. 2, the camera 110 may include a front camera 111 installed on a front windshield of the vehicle 1 and side cameras 112 installed on side surfaces of the vehicle 1.

The front camera 111 may have a forward field of view 111a of the vehicle 1, and the side camera 112 may have a sideward field of view 112a of the vehicle 1.

The camera 110 may include a plurality of lenses and an image sensor. The image sensor may include a plurality of photodiodes for converting light into electrical signals, and the plurality of photodiodes may be disposed in the form of a two-dimensional matrix.

The image data may include information on another vehicle, a pedestrian, a cyclist, or a lane line (marker for distinguishing a lane) positioned near the vehicle 1.

The driving assistance system 100 may include a processor for processing the image data of the camera 110, and the processor may be, for example, a component included in the camera 110 or may be a component included in the controller 140.

The processor may acquire image data from an image sensor of the camera 110 and detect and identify nearby objects of the vehicle 1 based on a result of processing the image data. For example, the processor may generate tracks corresponding to the nearby objects of the vehicle 1 by performing image processing and classify the generated tracks. The processor may identify whether the track is another vehicle, a pedestrian, or a cyclist, etc., and assign an identification code to the track.

The processor may transmit data (or positions and classifications of the tracks) on tracks (hereinafter referred to as “camera track”) near the vehicle 1 to the controller 140. The controller 140 may perform a driver assistance function or a driving assistance function based on the camera track.

The radar 120 may transmit transmission radio waves toward the surroundings of the vehicle 1 and detect the nearby objects of the vehicle 1 based on reflected radio waves reflected from the nearby objects. For example, as illustrated in FIG. 2, the radar 120 may be installed on a grille or a bumper of the vehicle 1 and may have a forward field of sensing 120a of the vehicle 1.

Although only one radar 120 is illustrated in the example of FIG. 2, a plurality of radars 120 may be provided in another example, and in this case, the radar 120 may include not only a front radar having a forward field of sensing but also corner radars having corner fields of sensing.

The radar 120 may include a transmission antenna (or a transmission antenna array) for radiating transmission radio waves toward the surroundings of the vehicle 1 and a reception antenna (or a reception antenna array) for receiving reflection signals, that is, the reflected radio waves that return after being reflected from objects.

The radar 120 may acquire radar data from the transmission radio waves transmitted by the transmission antenna and the reflected radio waves received by the reception antenna. The radar data may include position information (e.g., distance information) or speed information of objects in front of the vehicle 1.

The driving assistance system 100 may include a processor for processing the radar data, and the processor may be, for example, a component included in the radar 120 or may be a component included in the controller 140.

The processor may acquire the radar data from the reception antenna of the radar 120 and generate tracks corresponding to the objects by clustering reflection points of the reflection signals. The processor may, for example, acquire a distance to the track based on a time difference between a transmission time of the a transmission radio wave and a reception time of the reflected radio wave and acquire a relative speed of the track based on a frequency difference between the transmission radio wave and the reflected radio wave.

The processor may transmit data (or the distances and relative speeds of the tracks) on the tracks (hereinafter referred to as “radar track”) near the vehicle 1 acquired from the radar data to the controller 140. The controller 140 may perform a driver assistance function or a driving assistance function based on the radar track.

The LiDAR 130 may emit light (e.g., infrared rays) toward the surroundings of the vehicle 1 and detect nearby objects of the vehicle 1 based on reflected light reflected from the nearby objects. For example, as illustrated in FIG. 2, the LiDAR 130 may be installed on a roof of the vehicle 1 and may have a field of sensing 130a in all directions from the vehicle 1.

The LiDAR 130 may include a light source (e.g., a light emitting diode, a light emitting diode array, a laser diode, or a laser diode array) for emitting light (e.g., infrared rays) and an optical sensor (e.g., a photodiode or a photodiode array) for receiving light (e.g., infrared rays). In addition, as necessary, the LiDAR 130 may further include a driving device for rotating the light source or the optical sensor.

While the light source or the optical sensor rotates, the LiDAR 130 may emit light through the light source and receive the light reflected from objects through the optical sensor, thereby acquiring LiDAR data.

The LiDAR data may include relative positions (distances or directions of nearby objects) or relative speeds of the nearby objects of the vehicle 1.

The driving assistance system 100 may include a processor for processing the LiDAR data, and the processor may be, for example, a component included in the LiDAR 130 or may be a component included in the controller 140.

The processor may generate tracks corresponding to objects by clustering reflection points by the reflected light. The processor may, for example, acquire a distance to the object based on a time difference between a light transmission time and a light reception time. In addition, the processor may acquire a direction (or an angle) of the object with respect to a traveling direction of the vehicle 1 based on a direction in which the light source emits light when the optical sensor receives the reflected light.

The processor may transmit data (or the distances and relative speeds of the tracks) on the tracks (hereinafter referred to as “LiDAR track”) near the vehicle 1 acquired from the LiDAR data to the controller 140.

The controller 140 may be implemented as at least one of an electronic control unit (ECU) or a domain control unit (DCU) electrically connected to the camera 110, the radar 120, or the LiDAR 130.

The controller 140 may process the camera track (or the image data) of the camera 110, the radar track (or the radar data) of the radar 120, or the LiDAR track (or the LiDAR data) of the LiDAR 130 and provide control signals to the driving device 20, the braking device 30, or the steering device 40.

Alternatively, the controller 140 may output a warning to a user through at least one of the display device 50 or the audio device 60 based on a result of processing the image data, the radar data, or the LiDAR data.

The controller 140 may include at least one memory 142 for storing a program for performing an operation to be described below, for example, a program for determining a cut-in vehicle and at least one processor 141 for executing the stored program.

The memory 142 may store a program or data for processing the image data, the radar data, or the LiDAR data. In addition, the memory 142 may store programs or data for generating driving, braking, and steering signals.

The memory 142 may temporarily store the image data received from the camera 120, the radar data received from the radar 120, or the LiDAR data received from the LiDAR 130 and temporarily store a result of processing the image data, the radar data, or the LiDAR data of the processor 141.

In addition, the memory 142 may include a high definition (HD) map. Unlike general maps, the HD map may include detailed information on surfaces of roads or intersections, such as lane lines, traffic lights, intersections, and traffic signs. In particular, landmarks (e.g., a lane line, a traffic light, an intersection, and a traffic sign) that vehicles encounters while traveling are implemented in the form of a three dimension on the HD map.

The memory 142 may include not only volatile memories such as a static random access memory (SRAM) and a dynamic RAM (DRAM) but also non-volatile memories such as a flash memory, a read only memory (ROM), and an erasable programmable ROM (EPROM).

The processor 141 may process the camera track of the camera 120, the radar track of the radar 120, or the LiDAR track of the LiDAR 130. For example, the processor 141 may fuse the camera track, the radar track, or the LiDAR track and output fusion track.

Based on a result of processing the fusion track, the processor 141 may generate a driving signal, a braking signal, or a steering signal for respectively controlling the driving device 20, the braking device 30, or the steering device 40.

For example, the processor 141 may evaluate risk of collision between the fusion tracks and the vehicle 1. The processor 141 may control the driving device 20, the braking device 30, or the steering device 40 to steer or brake the vehicle 1 based on the risk of collision between the fusion tracks and the vehicle 1.

The processor 141 may include the image processor for processing the image data of the camera 110, the signal processor for processing the radar data of the radar 120, or the LiDAR data of the LiDAR 130, or a micro control unit (MCU) for generating driving, braking, and steering signals.

A detailed operation of the driving assistance system 100 will be described below in more detail.

In addition, although not illustrated in the drawings, a vehicle according to one embodiment may further include a communication module capable of communicating with other external devices. The communication module may wirelessly communicate with a base station or an access point (AP) and transmit or receive data with external devices via the base station or the AP.

For example, the communication module may wirelessly communicate with the AP using WiFi (WiFi™, IEEE 802.11 technical standard) or communicate with the base station using code division multiple access (CDMA), wideband CDMA (WCDMA), Global System for Mobiles (GSM), Long Term Evolution (LTE), fifth generation (5G), wireless broadband Internet (WiBro), etc.

In addition, the communication module may directly communicate with the external devices. For example, the communication module may transmit or receive data with short-range external devices using WiFi Direct, Bluetooth (Bluetooth™, IEEE 802.15.1 technical standard), ZigBee (ZigBee™, IEEE 802.15.4 technical standard), etc.

Meanwhile, all of the components illustrated in FIG. 1 are not necessarily included in the vehicle 1. For example, at least one of the radar 120 or the LiDAR 130 may be omitted.

In addition, although the camera 110, the radar 120, and the LiDAR 130 are illustrated in the drawings as components of the driving assistance system 100, it is not always necessary that these components be physically included in the driving assistance system 100.

Therefore, at least one of the camera 110, the radar 120, or the LiDAR 130 may be provided in the vehicle 1 as a component independent of the driving assistance system 100, and the driving assistance system 100 may acquire the image data or the camera track, the radar data or the radar track, or the LiDAR data or the LiDAR track from the at least one of the camera 110, the radar 120, or the LIDAR 130 provided in the vehicle 1.

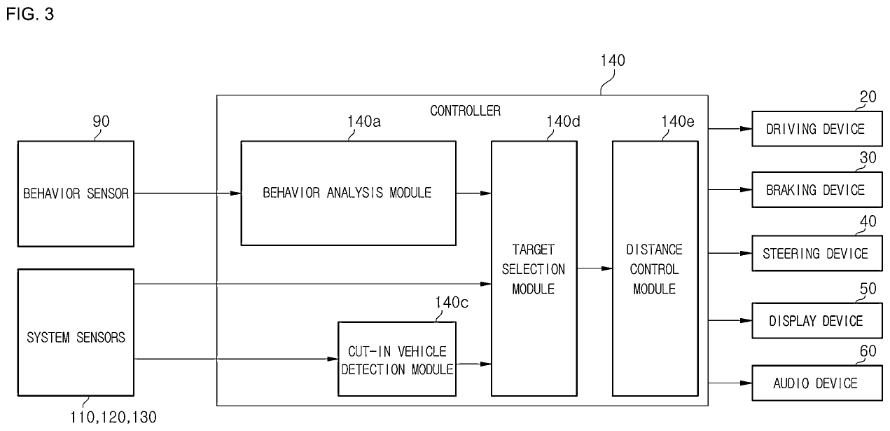

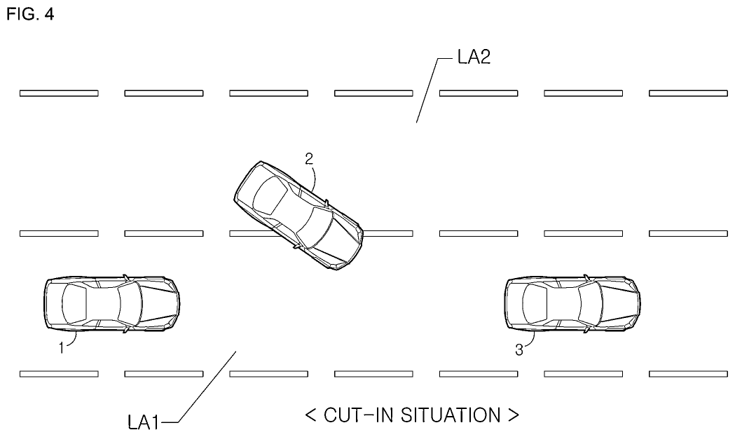

FIG. 3 is a block diagram illustrating operations performed by a controller of the driving assistance system according to one embodiment, and FIG. 4 is a view illustrating a cut-in situation of a nearby vehicle, which is one situation to which the driving assistance system needs to respond according to one embodiment.

Referring to FIG. 3, the controller 140 of the driving assistance system 100 according to one embodiment may include a behavior analysis module 140a, a cut-in vehicle detection module 140c, a target selection module 140d, and a distance control module 140e.

The behavior analysis module 140a may acquire various pieces of data related to a behavior of a vehicle from the behavior sensor 90. For example, the behavior analysis module 140a may acquire data such as a wheel speed, a longitudinal acceleration, a transverse acceleration, a yaw rate, a roll rate, or a pitch rate and analyze the behavior of the vehicle 1 based on the acquired data.

As described above, the driving assistance system 100 may perform an adaptive cruise control (ACC) function. In addition, since the driving assistance system 100 may perform autonomous driving, in both cases, the driving assistance system 100 may constantly maintain an inter-vehicle distance with a preceding vehicle and perform control for preventing collision with the preceding vehicle.

As illustrated in FIG. 4, while the vehicle 1 is traveling, a situation in which a nearby vehicle 2, which is traveling in a nearby lane LA2, changes the lane into a travel lane LA1 of the vehicle 1 to cut into the lane in front of the vehicle 1, that is, a cut-in situation may occur.

When the driving assistance system does not quickly detect a cut-in vehicle, a braking timing of the vehicle may be delayed, resulting in collision with the cut-in vehicle. The driving assistance system 100 according to one embodiment can reduce risk of collision with the cut-in vehicle by quickly detecting the cut-in vehicle. Hereinafter, an operation of the driving assistance system 100 that detects the cut-in vehicle will be described in detail.

Referring back to FIG. 3, the controller 140 of the driving assistance system 100 may include the cut-in vehicle detection module 140c for quickly detecting the cut-in vehicle. The cut-in vehicle detection module 140c may acquire at least one of the image data, the radar data, or the LiDAR data from the camera 110, the radar 120, or the LiDAR 130 and recognize the cut-in vehicle based on the acquired data.

Outputs of the behavior analysis module 140a and the cut-in vehicle detection module 140c may be input to the target selection module 140d. The target selection module 140d may select a target based on the behavior of the vehicle 1, a detection result or fusion result of the sensors 110, 120, and 130, a detection result of the cut-in vehicle, etc. Here, the selected target may be a distance control target of the vehicle 1.

The distance control module 140e may generate various control signals for controlling a distance between the vehicle 1 and the selected target. For example, the distance control module 140e may generate at least one of a driving signal, a braking signal, or a steering signal and transmit the signal to the driving device 20, the braking device 30, or the steering device 40.

In addition, the distance control module 140e may also transmit control signals to the display device 50 or the audio device 60 to output a visual warning or an audible warning.

Meanwhile, each of the modules illustrated in FIG. 3 is intended to represent operations performed by the controller 140 rather than representing physically independent components. Therefore, two or more of the behavior analysis module 140a, the cut-in vehicle detection module 140c, the target selection module 140d, and the distance control module 140e may share the same processor and memory.

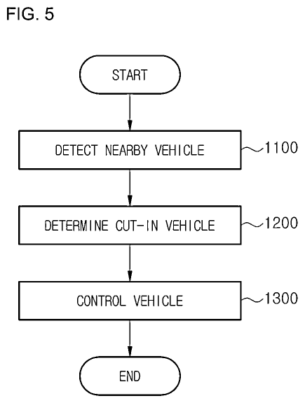

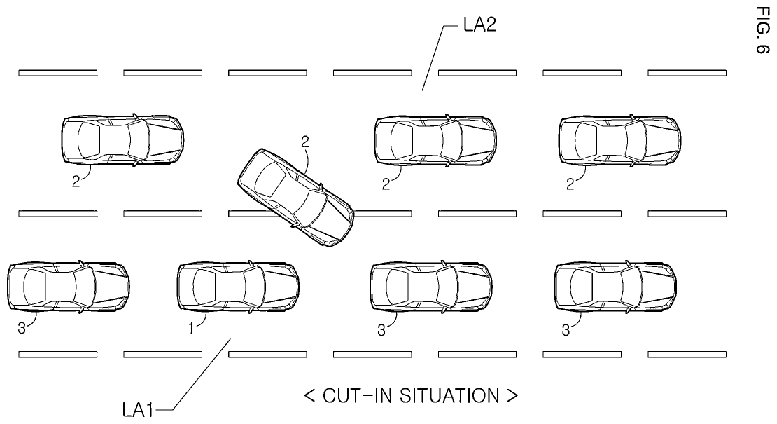

FIG. 5 is a flowchart illustrating a driving assistance method according to one embodiment, and FIG. 6 is a view illustrating a situation in which a cut-in vehicle is recognized by the driving assistance method according to one embodiment.

A driving assistance method according to one embodiment may be performed by the driving assistance system 100 or the vehicle 1 including the same. Therefore, a description of the driving assistance system 100 or the vehicle 1 may also be applied to the embodiment of the driving assistance method in the same manner even when not otherwise mentioned. In addition, a description of the driving assistance method to be described below may also be applied to the driving assistance system 100 or the vehicle 1 in the same manner even when not otherwise mentioned.

As illustrated in FIG. 5, in the driving assistance method according to one embodiment, nearby vehicles are detected (1100).

As an example for detecting the nearby vehicles, the image data acquired by the camera 110 may be used.

The detected nearby vehicles may include a preceding vehicle 3 or a following vehicle that is traveling in the same lane as the travel lane LA1 of the vehicle 1 and a vehicle 2 that is traveling in the nearby lane LA2 of the travel lane of the vehicle 1. For convenience of description, the nearby vehicle 2 that is traveling in the nearby lane LA2 will be referred to as a first nearby vehicle.

The nearby vehicle may be detected by the camera 110, and the camera 110 may output a result of detecting the nearby vehicle to the controller 140.

Alternatively, the controller 140 may detect the nearby vehicle based on the image data acquired by the camera 110.

The controller 140 may determine whether the detected nearby vehicle is a cut-in vehicle (1200).

The cut-in situation that occurs during travel on the road may be a situation in which the nearby vehicle in the nearby lane attempts to cut into the lane while the vehicle is traveling at a certain speed or higher in a state in which traffic flows smoothly, or as illustrated in FIG. 6, may be a situation in which the nearby vehicle in the nearby lane attempts to cut into the lane in a short range while the vehicle is traveling at a lower speed than the certain speed in a traffic congestion situation.

Since traveling speeds of the vehicles 1 and 2 are generally low in the traffic congestion situation, the speed of the nearby vehicle 2 is low and there is little movement even when the nearby vehicle 2 in the nearby lane LA2 attempts to cut into the lane. Therefore, there is a possibility that an error is included in a result of determining the cut-in vehicle based on the movement using the radar data or the LIDAR data.

In the driving assistance system 100 and the driving assistance method according to one embodiment, the cut-in vehicle may be determined based on the image data acquired by the camera 110. As illustrated in FIG. 6, in the traffic congestion situation, since the first nearby vehicle 2 positioned adjacent to the vehicle 1 attempts to cut into the lane at a short range, a steering angle tends to be large.

Therefore, in the driving assistance system 100 and the driving assistance method according to one embodiment, it is possible to check a steering angle of the front wheel of the nearby vehicle in the nearby lane based on the image data and increase the accuracy of the cut-in vehicle determination by determining the cut-in vehicle based on the checking result.

Referring back to FIG. 5, the controller 140 may control the vehicle 1 based on the result of determining the cut-in vehicle (1300).

As the determination result based on the image data, when the first nearby vehicle 2 corresponds to the cut-in vehicle, control of responding to the cut-in vehicle may be performed, and when the first nearby vehicle 2 does not correspond to the cut-in vehicle, the vehicle 1 may continuously maintain the current travel.

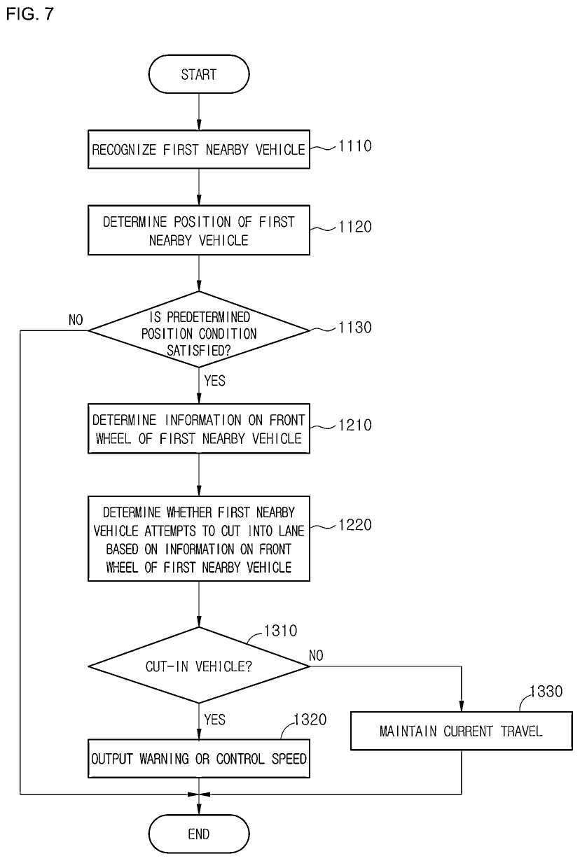

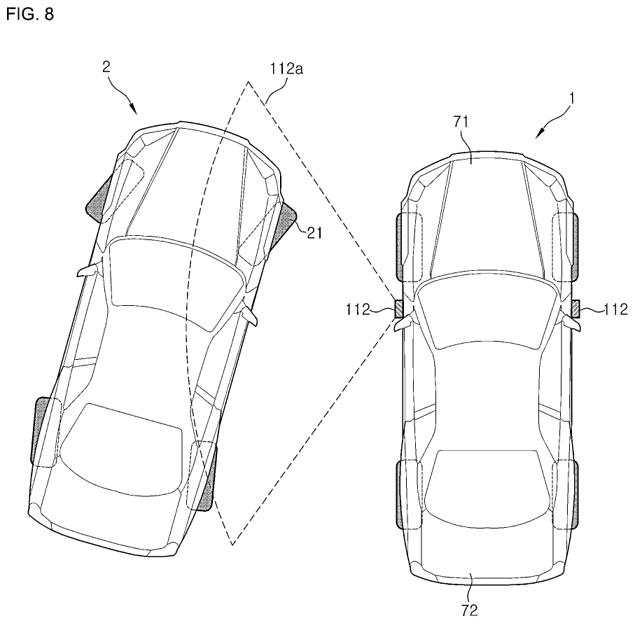

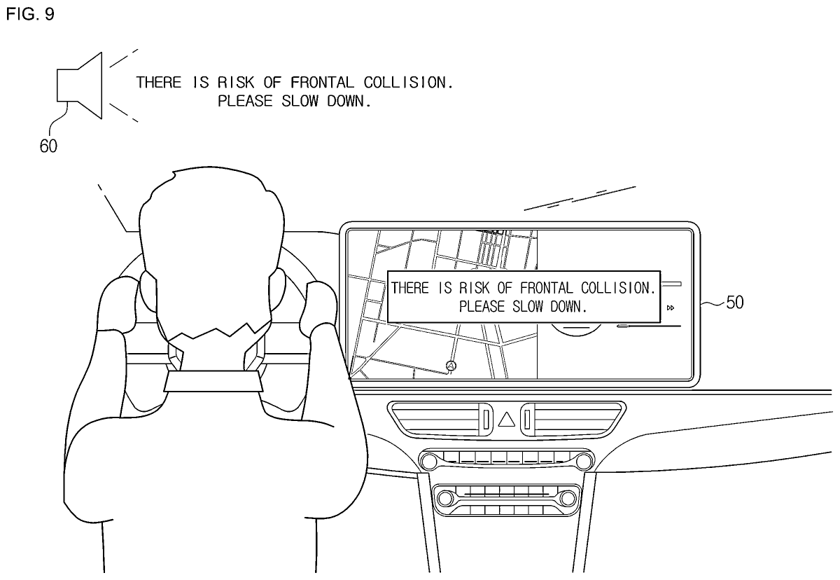

FIG. 7 is a flowchart specifically illustrating the driving assistance method according to one embodiment, FIG. 8 is a view illustrating data used in the driving assistance method according to one embodiment, and FIG. 9 is a view illustrating an operation in response to a cut-in vehicle in the driving assistance method according to one embodiment.

Referring to FIG. 7, in the driving assistance method according to one embodiment, the first nearby vehicle traveling in the nearby lane may be recognized (1110), and a position of the recognized first nearby vehicle may be determined (1120).

For example, the controller 140 may recognize the first nearby vehicle 2 that is traveling in the nearby lane LA2 based on the image data acquired by the side cameras 112 and determine a relative position of the first nearby vehicle 2.

When a predetermined position condition is satisfied (YES in 1130), a process for determining whether the nearby vehicle is the cut-in vehicle may be performed.

As illustrated in FIG. 8, the controller 140 may recognize a front wheel 21 of the first nearby vehicle 2 based on the image data. The image data used here may be the image data acquired by the side cameras 112.

In order to determine whether the position of the first nearby vehicle 2 satisfies the predetermined position condition (1130), the controller 140 may determine whether the front wheel 21 of the first nearby vehicle 2 recognized from the image data is positioned within a predetermined range.

For example, when the front wheel 21 of the first nearby vehicle 2 is positioned between a rear bumper 72 and a front bumper 71 of the vehicle 1, it may be determined that the predetermined position condition is satisfied. Alternatively, it is also possible to set an offset forward by a predetermined distance from the position of the front bumper 71 according to the fields of view 112a of the side cameras 112.

When the predetermined position condition is satisfied (YES in 1130), the controller 140 may determine information on the front wheel 21 of the first nearby vehicle 2 (1210) and determine whether the first nearby vehicle 2 attempts to cut into the lane based on the information on the front wheel 21 of the first nearby vehicle 2 (1220).

When it is determined that the first nearby vehicle 2 is the cut-in vehicle (YES in 1310), the controller 140 may respond to the cut-in vehicle by outputting a warning or controlling a speed (1320).

In the case of outputting the warning, as illustrated in FIG. 9, a warning message in which a vehicle needs to slow down because there is risk of frontal collision may be visually output through the display device 50 or the same warning message may be audibly output through the audio device 60.

In the example of FIG. 9, a case in which the warning on the cut-in vehicle is output both visually and audibly is illustrated, but the embodiment of the present disclosure is not limited thereto. It goes without saying that only one of the visual warning and the audible warning may also be output.

When it is determined that the first nearby vehicle 2 is not the cut-in vehicle (NO in 1310), the controller 140 may maintain the current travel (1330).

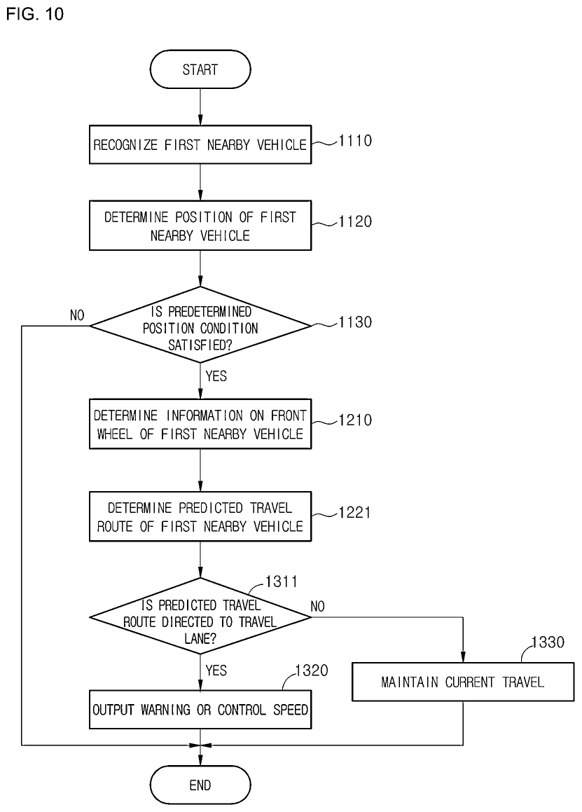

FIG. 10 is another flowchart illustrating the driving assistance method according to one embodiment.

Referring to FIG. 10, in the driving assistance method according to one embodiment, the first nearby vehicle traveling in the nearby lane may be recognized (1110), and a position of the recognized first nearby vehicle traveling in the nearby lane may be determined (1120).

For example, the controller 140 may recognize the first nearby vehicle 2 that is traveling in the nearby lane LA2 based on the image data acquired by the side cameras 112 and determine the relative position of the first nearby vehicle 2.

When a predetermined position condition is satisfied (YES in 1130), a process for determining whether the nearby vehicle is the cut-in vehicle may be performed.

As described above, the controller 140 may recognize the front wheel 21 of the first nearby vehicle 2 based on the image data. The image data used here may be the image data acquired by the side cameras 112.

In order to determine whether the position of the first nearby vehicle 2 satisfies the predetermined position condition (1130), the controller 140 may determine whether the front wheel 21 of the first nearby vehicle 2 recognized from the image data are positioned within the predetermined range.

For example, when the front wheel 21 of the first nearby vehicle 2 is positioned between the rear bumper 72 and the front bumper 71 of the vehicle 1, it may be determined that the predetermined position condition is satisfied. Alternatively, it is also possible to set the offset forward by the predetermined distance from the position of the front bumper 71 according to the fields of view 112a of the side cameras 112.

When the predetermined position condition is satisfied (YES in 1130), the controller 140 may determine the information on the front wheel 21 of the first nearby vehicle 1 (1210).

In addition, the controller 140 may determine a predicted travel route of the first nearby vehicle 2 based on the information on the front wheel 21 of the first nearby vehicle 2 (1221), and, when the predicted travel route of the first nearby vehicle 2 is directed to the travel lane LA1 of the vehicle 1 (YES in 1311), output a warning or control a speed by determining that the first nearby vehicle 2 is the cut-in vehicle (1320).

When the predicted travel route of the first nearby vehicle 2 is not directed to the travel lane LA1 of the vehicle 1 (NO in 1311), the controller 140 may maintain the current travel (1330).

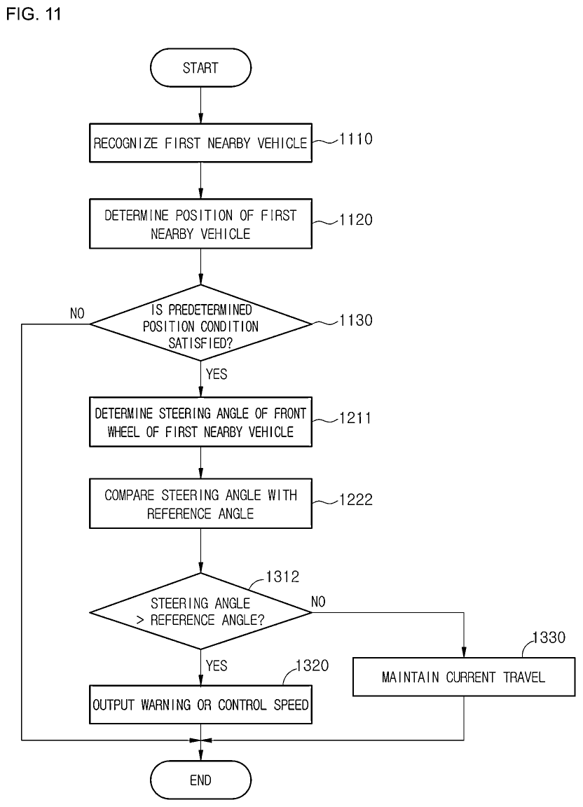

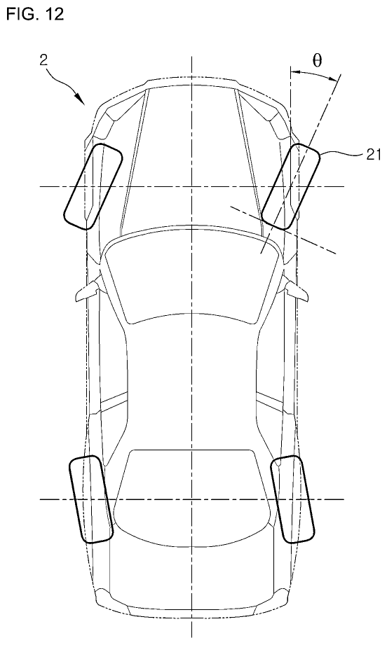

FIG. 11 is still another flowchart of the driving assistance method according to one embodiment, and FIG. 12 is a view illustrating data used in the driving assistance method according to one embodiment.

Referring to FIG. 11, in the driving assistance method according to one embodiment, the first nearby vehicle traveling in the nearby lane may be recognized (1110), and a position of the recognized first nearby vehicle traveling in the nearby lane may be determined (1120).

For example, the controller 140 may recognize the first nearby vehicle 2 that is traveling in the nearby lane LA2 based on the image data acquired by the side cameras 112 and determine the relative position of the first nearby vehicle 2.

When a predetermined position condition is satisfied (YES in 1130), a process for determining whether the nearby vehicle is the cut-in vehicle may be performed.

As described above, the controller 140 may recognize the front wheel 21 of the first nearby vehicle 2 based on the image data. The image data used here may be the image data acquired by the side cameras 112.

In order to determine whether the position of the first nearby vehicle 2 satisfies the predetermined position condition (1130), the controller 140 may determine whether the front wheel 21 of the first nearby vehicle 2 recognized from the image data is positioned within the predetermined range.

For example, when the front wheel 21 of the first nearby vehicle 2 is positioned between the rear bumper 72 and the front bumper 71 of the vehicle 1, it may be determined that the predetermined position condition is satisfied. Alternatively, it is also possible to set the offset forward by the predetermined distance from the position of the front bumper 71 according to the fields of view 112a of the side cameras 112.

When the predetermined position condition is satisfied (YES in 1130), the controller 140 may determine the steering angle of the front wheel 21 of the first nearby vehicle 2 as the information on the front wheel 21 of the first nearby vehicle 2 (1211).

Referring to FIG. 12, a steering angle θ of the front wheel 21 of the first nearby vehicle 2 that attempts to cut into a nearby lane in a short range increases at a certain angle or more in a direction of the travel lane LA1. Therefore, when the steering angle θ of the front wheel 21 of the first nearby vehicle 2 exceeds a reference angle (YES in 1312), the controller 140 may determine that the first nearby vehicle 2 is the cut-in vehicle and output a warning or control a speed (1320).

When the steering angle θ of the front wheel 21 of the first nearby vehicle 2 is smaller than or equal to the reference angle (NO in 1312), the controller 140 may maintain the current travel (1330).

Meanwhile, according to the embodiment of the driving assistance method, it is also possible to differently apply the method of determining whether the nearby vehicle traveling in the nearby lane attempts to cut into the lane according to the speed of the vehicle 1.

For example, when the speed of the vehicle 1 exceeds a reference speed, the controller 140 may determine whether the nearby vehicle traveling in the nearby lane attempts to cut into the lane based on at least one of the radar data acquired by the radar 120 or the LiDAR data acquired by the LiDAR 130.

On the other hand, when the speed of the vehicle 1 is lower than or equal to the reference speed, this may be regarded as a traffic congestion situation, and the nearby vehicle that is traveling in the nearby lane attempts to cut into the lane in a short range in many cases. Therefore, according to the above-described process, it is possible to determine whether the nearby vehicle traveling in the nearby lane attempts to cut into the lane based on the image data acquired by the camera 110.

As is apparent from the above description, it is possible to determine whether a nearby vehicle attempts to cut into the lane based on images captured through a camera, thereby increasing the accuracy of determination of a cut-in vehicle in a congestion situation and improving the reliability of a driving assistance system.

Exemplary embodiments of the present disclosure have been described above. In the exemplary embodiments described above, some components may be implemented as a “module”. Here, the term ‘module’ means, but is not limited to, a software and/or hardware component, such as a Field Programmable Gate Array (FPGA) or Application Specific Integrated Circuit (ASIC), which performs certain tasks. A module may advantageously be configured to reside on the addressable storage medium and configured to execute on one or more processors.

Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The operations provided for in the components and modules may be combined into fewer components and modules or further separated into additional components and modules. In addition, the components and modules may be implemented such that they execute one or more CPUs in a device.

With that being said, and in addition to the above described exemplary embodiments, embodiments can thus be implemented through computer readable code/instructions in/on a medium, e.g., a computer readable medium, to control at least one processing element to implement any above described exemplary embodiment. The medium can correspond to any medium/media permitting the storing and/or transmission of the computer readable code.

The computer-readable code can be recorded on a medium or transmitted through the Internet. The medium may include Read Only Memory (ROM), Random Access Memory (RAM), Compact Disk-Read Only Memories (CD-ROMs), magnetic tapes, floppy disks, and optical recording medium. Also, the medium may be a non-transitory computer-readable medium. The media may also be a distributed network, so that the computer readable code is stored or transferred and executed in a distributed fashion. Still further, as only an example, the processing element could include at least one processor or at least one computer processor, and processing elements may be distributed and/or included in a single device.

While exemplary embodiments have been described with respect to a limited number of embodiments, those skilled in the art, having the benefit of this disclosure, will appreciate that other embodiments can be devised which do not depart from the scope as disclosed herein. Accordingly, the scope should be limited only by the attached claims.

What is claimed is:

1. An apparatus for driving assistance, the apparatus comprising:
at least one memory in which a program for determining a cut-in vehicle is stored; and
at least one processor configured to execute the stored program,
wherein the at least one processor is configured to:
acquire image data from a camera;
identify a first nearby vehicle traveling in a lane near a vehicle from the image data;
identify a front wheel of the first nearby vehicle from the image data; and
determine whether the first nearby vehicle attempts to cut into a travel lane in which the vehicle is traveling, based on information on the front wheel of the first nearby vehicle.

2. The apparatus of claim 1, wherein the at least one processor is configured to acquire a steering angle of the front wheel of the first nearby vehicle based on the image data.

3. The apparatus of claim 2, wherein the at least one processor is configured to determine that the first nearby vehicle is the cut-in vehicle, based on the steering angle of the front wheel of the first nearby vehicle exceeding a reference angle.

4. The apparatus of claim 1, wherein the at least one processor is configured to determine a predicted travel route of the first nearby vehicle, based on the information on the front wheel of the first nearby vehicle.

5. The apparatus of claim 4, wherein the at least one processor is configured to determine that the first nearby vehicle is the cut-in vehicle, based on the predicted travel route of the first nearby vehicle that is directed to the travel lane.

6. The apparatus of claim 5, wherein the at least one processor is configured to determine that the predicted travel route of the first nearby vehicle is directed to the travel lane, based on a steering angle of the front wheel of the first nearby vehicle exceeding a reference angle.

7. The apparatus of claim 1, wherein the at least one processor is configured to:
determine the cut-in vehicle based on the image data acquired from the camera when a speed of the vehicle is smaller than or equal to a predetermined reference value; and
determine the cut-in vehicle based on at least one of radar data acquired from a radar provided in the vehicle or light detection and ranging (LiDAR) data acquired from a LiDAR provided in the vehicle when the speed of the vehicle exceeds the predetermined reference value.

8. An apparatus for driving assistance, the apparatus comprising:
a camera provided on a vehicle; and
at least one processor configured to execute a program stored in a memory,
wherein the at least one processor is configured to:
acquire image data from the camera;
identify a first nearby vehicle that is traveling in a lane near the vehicle from the image data;
identify a front wheel of the first nearby vehicle from the image data; and
determine whether the first nearby vehicle attempts to cut into a travel lane in which the vehicle is traveling based on information on the front wheel of the first nearby vehicle.

9. The apparatus of claim 8, wherein the at least one processor is configured to acquire a steering angle of the front wheel of the first nearby vehicle based on the image data.

10. The apparatus of claim 9, wherein the at least one processor is configured to determine that the first nearby vehicle is the cut-in vehicle based on the steering angle of the front wheel of the first nearby vehicle exceeding a reference angle.

11. The apparatus of claim 8, wherein the at least one processor is configured to determine a predicted travel route of the first nearby vehicle based on the information on the front wheel of the first nearby vehicle.

12. The apparatus of claim 11, wherein the at least one processor is configured to determine that the first nearby vehicle is the cut-in vehicle based on the predicted travel route of the first nearby vehicle that is directed to the travel lane.

13. The apparatus of claim 12, wherein the at least one processor is configured to determine that the predicted travel route of the first nearby vehicle is directed to the travel lane based on a steering angle of the front wheel of the first nearby vehicle exceeding a reference angle.

14. The apparatus of claim 9, wherein the at least one processor is configured to:
determine the cut-in vehicle based on the image data acquired from the camera when a speed of the vehicle is smaller than or equal to a predetermined reference value; and
determine the cut-in vehicle based on at least one of radar data acquired from a radar provided in the vehicle or light detection and ranging (LiDAR) data acquired from a LiDAR provided in the vehicle when the speed of the vehicle exceeds the predetermined reference value.

15. A method for driving assistance, the method comprising:
acquiring image data from a camera provided on a side surface of a vehicle;
identifying a first nearby vehicle that is traveling in a lane near the vehicle from the image data;
identifying a front wheel of the first nearby vehicle from the image data; and
determining whether the first nearby vehicle attempts to cut into a travel lane in which the vehicle is traveling based on information on the front wheel of the first nearby vehicle.

16. The driving assistance method of claim 15, wherein the recognizing of the first nearby vehicle comprises acquiring a steering angle of the front wheel of the first nearby vehicle based on the image data.

17. The driving assistance method of claim 16, wherein the determining of whether the first nearby vehicle is the cut-in vehicle comprises determining that the first nearby vehicle is the cut-in vehicle, based on the steering angle of the front wheel of the first nearby vehicle exceeding a reference angle.

18. The driving assistance method of claim 15, wherein the determining of whether the first nearby vehicle is the cut-in vehicle comprises determining a predicted travel route of the first nearby vehicle based on the information on the front wheel of the first nearby vehicle.

19. The driving assistance method of claim 18, wherein the determining of whether the first nearby vehicle is the cut-in vehicle comprises determining that the first nearby vehicle is the cut-in vehicle based on the predicted travel route of the first nearby vehicle that is directed to the travel lane.

20. The driving assistance method of claim 19, wherein the determining of whether the first nearby vehicle is the cut-in vehicle comprises determining that the predicted travel route of the first nearby vehicle is directed to the travel lane based on a steering angle of the front wheel of the first nearby vehicle exceeding a reference angle.
